(19) United States
(12) Patent Application Publication
(10) Pub. No.: US 2018/0352796 A1
(43) Pub. Date: Dec. 13, 2018

(54) Insect Killing Assembly

(71) Applicant: Oscar L. Chattman, Warren, OH (US)

(72) Inventor: Oscar L. Chattman, Warren, OH (US)

(21) Appl. No.: 15/616,404

(22) Filed: Jun. 7, 2017

(51) Int. Cl. A01M 1/22; A01M 1/02; A01M 1/10

(52) U.S. Cl. CPC A01M 1/223; A01M 1/106; A01M 1/02

(57) ABSTRACT

A insect killing assembly for attracting and killing insects includes a container. A liquid may be poured into the container thereby facilitating the liquid to attract insects to the container. A shock unit is removably coupled to the container. The shock unit electrocutes the insects when the insects attempt to enter the container.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

### (2) Description of Related Art Including Information Disclosed Under 37 CFR 1.97 and 1.98

The disclosure and prior art relates to killing devices and more particularly pertains to a new killing device for attracting and killing insects.

### BRIEF SUMMARY OF THE INVENTION

An embodiment of the disclosure meets the needs presented above by generally comprising a container. A liquid may be poured into the container thereby facilitating the liquid to attract insects to the container. A shock unit is removably coupled to the container. The shock unit electrocutes the insects when the insects attempt to enter the container.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a top perspective view of a insect killing assembly according to an embodiment of the disclosure.

FIG. 2 is a bottom view of an embodiment of the disclosure.

FIG. 3 is an exploded perspective view of an embodiment of the disclosure.

FIG. 4 is a phantom in-use view of an embodiment of the disclosure.

FIG. 5 is a schematic view of an embodiment of the disclosure.

### DETAILED DESCRIPTION OF THE INVENTION

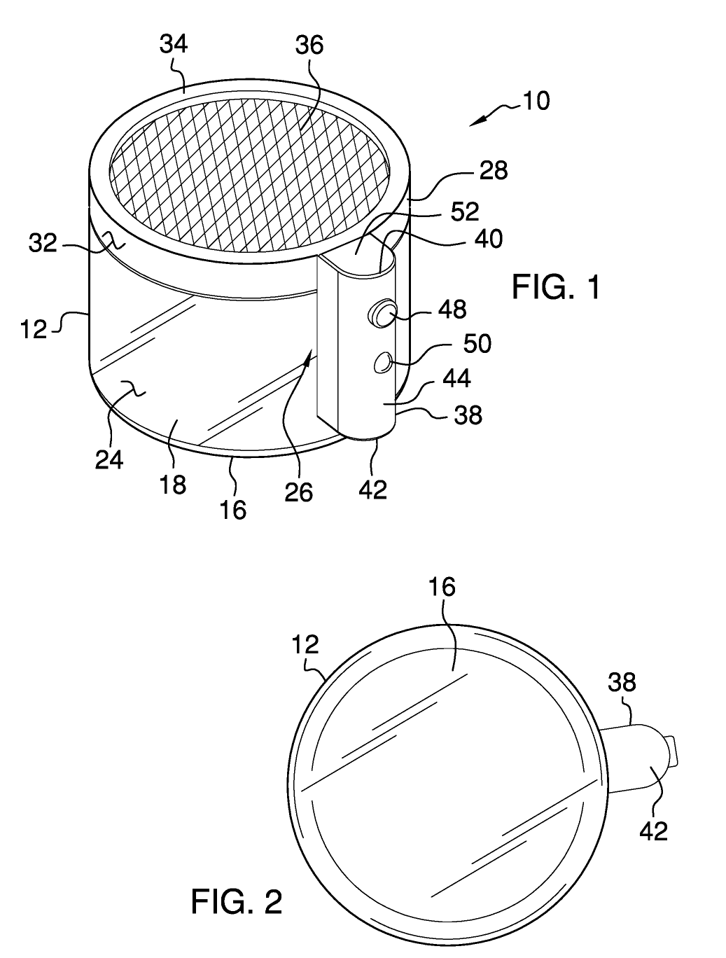

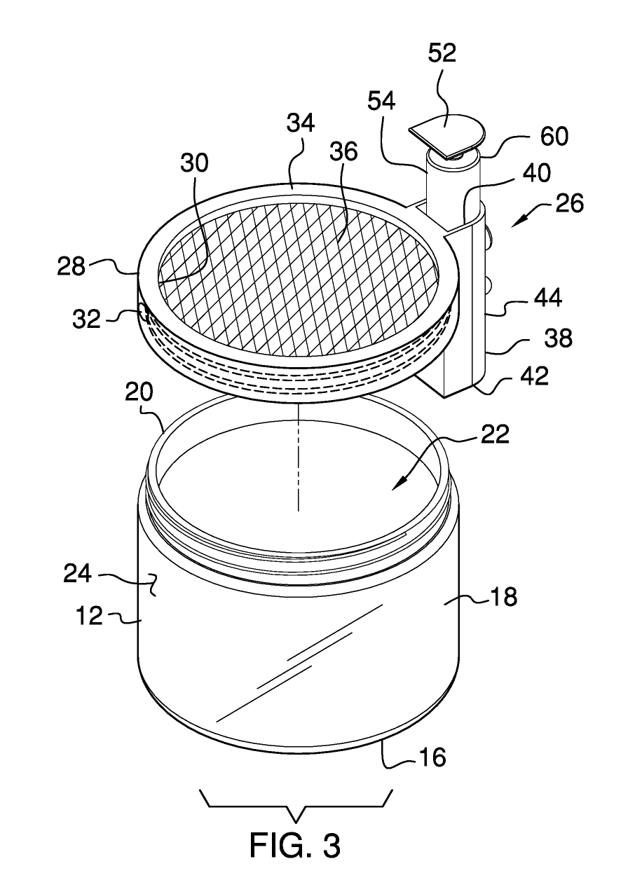

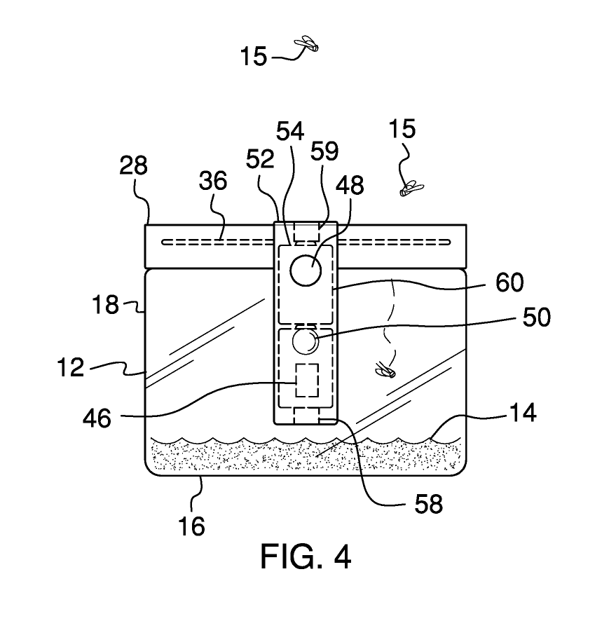

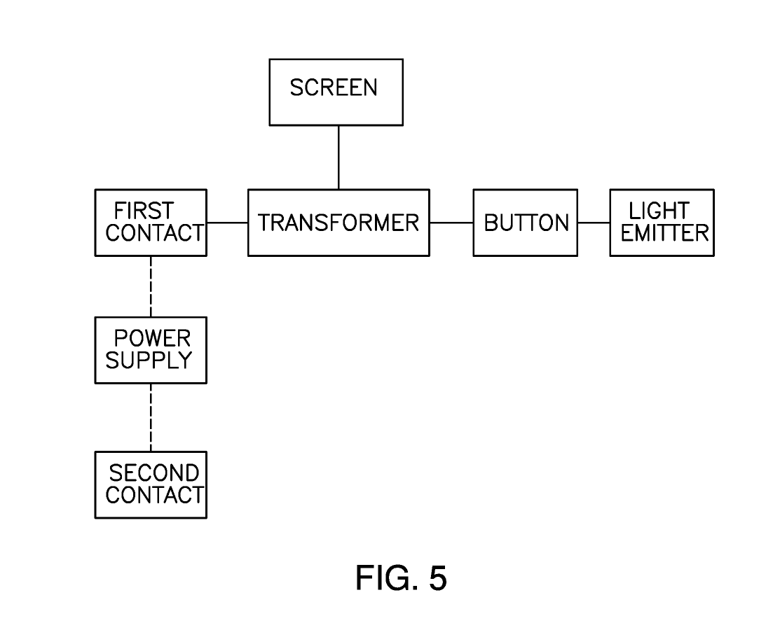

With reference now to the drawings, and in particular to FIGS. 1 through 5 thereof, a new killing device embodying the principles and concepts of an embodiment of the disclosure and generally designated by the reference numeral 10 will be described.

As best illustrated in FIGS. 1 through 5, the insect killing assembly 10 generally comprises a container 12 that may contain a liquid 14 thereby facilitating the liquid 14 to attract insects 15 to the container 12. The liquid 14 may be wine, fruit juice and any other liquid 14 that attracts winged insects 15, such as fruit flies, house flies and other winged insects 15. The container 12 has a bottom wall 16 and a perimeter wall 18 extending upwardly therefrom. The perimeter wall 18 has a distal edge 20 with respect to the bottom wall 16 to define an opening 22 into the container 12. Moreover, the perimeter wall 18 has an outer surface 24 and the outer surface 24 is threaded adjacent to the distal edge 20.

A shock unit 26 is provided and the shock unit 26 is removably coupled to the container 12. The shock unit 26 electrocutes the insects 15 when the insects 15 attempt to enter the container 12. The shock unit 26 comprises a ring 28 that has an inwardly facing surface 30, an outwardly facing surface 32 and a top edge 34. The inwardly facing surface 30 is threaded such that the ring 28 threadably engages the perimeter wall 18 of the container 12.

A screen 36 is coupled to the inwardly facing surface 30 of the ring 28. The screen 36 is coextensive with the inwardly facing surface 30 such that the screen 36 covers the container 12 when the ring 28 is positioned on the container 12. Moreover, the screen 36 is comprised of an electrically conductive material such as steel or the like.

A housing 38 is coupled to the ring 28 and the housing 38 has a first end 40, a second end 42 and an outer wall 44 extending therebetween. The housing 38 is elongated between the first 40 and second 42 ends. The outer wall 44 is coupled to the outwardly facing surface 32 of the ring 28 having the first end 40 being aligned with the top edge 34 of the ring 28. The housing 38 extends downwardly along the perimeter wall 18 of the container 12 when the ring 28 is removably coupled to the container 12. The first end 40 is open and the housing 38 is substantially hollow.

A transformer 46 is positioned within the housing 38 and the transformer 46 is electrically coupled to the screen 36. The transformer 46 may be a step-up, DC transformer 46 that has an output voltage ranging between approximately 2000.0 VDC and 2500.00 VDC. A button 48 is coupled to the outer wall 44 of the housing 38 wherein the button 48 is selectively manipulated. The button 48 is electrically coupled to the transformer 46 such that the button 48 turns the transformer 46 on and off. A light emitter 50 is coupled to the outer wall 44 of the housing 38 to selectively emit light outwardly therefrom. The light emitter 50 is electrically coupled to the button 48 such that the button 48 turns the light emitter 50 on and off. The light emitter 50 is turned on when the transformer 46 is turned.

A lid 52 is removably coupled to the first end 40 of the housing 38 to close the first end 40. A power supply 54 is removably positioned within the housing 38. The power supply 54 is electrically coupled to the transformer 46 when the power supply 54 is positioned in the housing 38. In this way the transformer 46 communicates an electrical current to the screen 36.

The power supply 54 comprises a first contact 58 that is positioned within the housing 38. The first contact 58 is electrically coupled to the transformer 46. A second contact 59 is coupled to the lid 52. The second contact 59 is in electrical communication with the transformer 46 when the lid 52 is positioned on the housing 38. At least one battery 60 is removably positioned within the housing 38. The at least one battery 60 is in electrical communication with each of the first 58 and second 59 contacts when the at least one battery 60 is positioned in the housing 38 and the lid 52 is positioned on the housing 38.

In use, the liquid 14 is poured into the container 12 and the ring 28 is threadably coupled to the container 12. In this way the insects 15 are attracted to land on the screen 36 in the attempt to enter the container 12. The container 12 is positioned in a location known to be inhabited by flying insects 15. The button 48 is selectively manipulated to turn the transformer 46 on. Thus, the insects 15 are electrocuted when the insects 15 land on the screen 36. The liquid 14 is refreshed when the liquid 14 evaporates and when liquid 14 is filled with dead insects 15.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. An insect killing assembly being configured to electrocute and collect insects, said assembly comprising:
a container being configured to contain a liquid thereby facilitating the liquid to attract insects to said container; and
a shock unit being removably coupled to said container wherein said shock unit is configured to electrocute the insects when the insects attempt to enter said container.

2. The assembly according to claim 1, wherein said container has a bottom wall and a perimeter wall extending upwardly therefrom, said perimeter wall having a distal edge with respect to said bottom wall to define an opening into said container, said perimeter wall having an outer surface, said outer surface being threaded adjacent to said distal edge.

3. The assembly according to claim 2, wherein:
said container has a perimeter wall; and
said shock unit comprises a ring having an inwardly facing surface, an outwardly facing surface and a top edge, said inwardly facing surface being threaded such that said ring threadably engages said perimeter wall of said container.

4. The assembly according to claim 3, further comprising a screen being coupled to said inwardly facing surface of said ring, said screen being coextensive with said inwardly facing surface such that said screen covers said container when said ring is positioned on said container.

5. The assembly according to claim 3, further comprising a housing having a first end, a second end and an outer wall extending therebetween, said housing being elongated between said first and second ends, said outer being coupled to said outwardly facing surface of said ring having said first end being aligned with said top edge of said ring, said housing extending downwardly along said perimeter wall of said container when said ring is removably coupled to said container, said first end being open, said housing being substantially hollow.

6. The assembly according to claim 5, further comprising:
a screen being coupled to said ring; and
a transformer being positioned within said housing, said transformer being electrically coupled to said screen.

7. The assembly according to claim 5, further comprising a button being coupled to said outer wall of said housing wherein said button is configured to be manipulated, said button being electrically coupled to said transformer such that said button turns said transformer on and off.

8. The assembly according to claim 7, further comprising a light emitter being coupled to said outer wall of said housing wherein said light emitter is configured to selectively emit light outwardly therefrom, said light being electrically coupled to said button such that said button turns said light emitter on and off.

9. The assembly according to claim 5, further comprising a lid being removably coupled to said first end of said housing to close said first end.

10. The assembly according to claim 6, further comprising a power supply being removably positioned within said housing, said power supply being electrically coupled to said transformer when said power supply is positioned in said housing wherein said transformer is configured to communicate an electrical current to said screen.

11. The assembly according to claim 10, wherein said power supply comprising:
a first contact being positioned within said housing, said first contact being electrically coupled to said transformer; and
a second contact 59 being coupled to said lid, said second contact 59 being in electrical communication with said transformer when said lid is positioned on said housing.

12. The assembly according to claim 11, further comprising at least one battery being removably positioned within said housing, said at least one battery being in electrical communication with each of said first and second contact 59s when said at least one battery is positioned in said housing and said lid is positioned on said housing.

13. An insect killing assembly being configured to electrocute and collect insects, said assembly comprising:
a container being configured to contain a liquid thereby facilitating the liquid to attract insects to said container, said container having a bottom wall and a perimeter wall extending upwardly therefrom, said perimeter wall having a distal edge with respect to said bottom wall to define an opening into said container, said perimeter wall having an outer surface, said outer surface being threaded adjacent to said distal edge; and
a shock unit being removably coupled to said container wherein said shock unit is configured to electrocute the insects when the insects attempt to enter said container, said shock unit comprising:
a ring having an inwardly facing surface, an outwardly facing surface and a top edge, said inwardly facing surface being threaded such that said ring threadably engages said perimeter wall of said container,
a screen being coupled to said inwardly facing surface of said ring, said screen being coextensive with said inwardly facing surface such that said screen covers said container when said ring is positioned on said container,
a housing having a first end, a second end and an outer wall extending therebetween, said housing being elongated between said first and second ends, said outer being coupled to said outwardly facing surface of said ring having said first end being aligned with said top edge of said ring, said housing extending downwardly along said perimeter wall of said container when said ring is removably coupled to said container, said first end being open, said housing being substantially hollow,
a transformer being positioned within said housing, said transformer being electrically coupled to said screen,
a button being coupled to said outer wall of said housing wherein said button is configured to be manipulated, said button being electrically coupled to said transformer such that said button turns said transformer on and off,
a light emitter being coupled to said outer wall of said housing wherein said light emitter is configured to selectively emit light outwardly therefrom, said light being electrically coupled to said button such that said button turns said light emitter on and off,
a lid being removably coupled to said first end of said housing to close said first end, and
a power supply being removably positioned within said housing, said power supply being electrically coupled to said transformer when said power supply is positioned in said housing wherein said transformer is configured to communicate an electrical current to said screen, said power supply comprising:
a first contact being positioned within said housing, said first contact being electrically coupled to said transformer,
a second contact 59 being coupled to said lid, said second contact 59 being in electrical communication with said transformer when said lid is positioned on said housing, and
at least one battery being removably positioned within said housing, said at least one battery being in electrical communication with each of said first and second contact 59s when said at least one battery is positioned in said housing and said lid is positioned on said housing.
